(19) United States
(12) Patent Application Publication
(10) Pub. No.: US 2025/0092925 A1
(43) Pub. Date: Mar. 20, 2025

(54) ECCENTRIC BRAKE PAD

(71) Applicants: Beringer Aero, Tallard (FR); Beringer, Saint Jean D'Ardieres (FR)

(72) Inventors: Gilbert Beringer, Fouillouse (FR); Etienne Bocard, Saint Jean D'Ardieres (FR)

(73) Assignees: Beringer Aero, Tallard (FR); Beringer, Saint Jean D'Ardieres (FR)

(21) Appl. No.: 18/728,920

(22) PCT Filed: Oct. 20, 2022
(86) PCT No.: PCT/FR2022/051990

§ 371 Date: Jul. 15, 2024

(30) Foreign Application Priority Data
Jan. 31, 2022 (FR) 2200815

(51) Int. Cl. F16D 65/00; F16D 55/00; F16D 65/092; F16D 65/12

(52) U.S. Cl. CPC F16D 65/0068; F16D 55/00; F16D 65/092; F16D 65/125; F16D 2055/0016

(57) ABSTRACT

The invention relates to a brake pad for a disc brake caliper, comprising a support plate with a rear face presenting a support zone and a front face receiving a friction material with a friction zone intended to engage with a brake disc in a friction direction.

According to the invention, the center of the support zone is offset relative to the center of the friction zone, in a direction opposite to the friction direction, by a value D, such that 0.1 μE≤D≤2 μE, where:
μ is the friction coefficient of the friction zone against the disc; and
E is the distance between the friction zone and the center of a mounting surface of the pad, measured orthogonally to the friction zone.

### TECHNICAL FIELD

The invention relates to the technical field of disc brakes, and more particularly to the pads used in such brakes.

### BACKGROUND ART

In the field of disc brakes, braking force is directly related to parameters such as:
The material of the pads;
The material of the disc;
The surface area of the friction zone between the pads and the disc;
The clamping force of the pads on the disc.

The performance of the braking system is also linked to:
The obtainable braking force;
Kinetic parameters, such as the rotational speed of the disc, the kinetic energy of the vehicle equipped with the brake, and particularly the kinetic energy to be dissipated during each braking;
The frequency of brake use over time;
The thermal parameters of the brake, especially its ability to resist the heat generated during the conversion of kinetic energy into thermal energy, or to dissipate this heat.

The braking performance is also related to the dynamic behavior of the pads during use. Uneven wear of the pads leads to an uneven distribution of braking force and, consequently, an uneven distribution of the heat to be dissipated. Notably, brake pads tend to wear more on one side, resulting in the friction surface of the pad no longer being parallel to the backing plate after use.

Furthermore, uneven wear of the pads leads to more frequent replacements, even when some friction material remains in certain areas.

Documents JP2010007729A, JPH08014282, U.S. Pat. No. 2,937,722A1, and CN107956821A describe brake pads for disc calipers, where the friction material is offset in a direction opposite to the friction direction.

### SUMMARY OF THE INVENTION

One of the objectives of the invention is to overcome the disadvantages of the prior art by proposing a brake pad optimized for disc brakes to ensure even wear distribution, leading to better braking performance.

Another objective is to propose brake pads with the most even wear distribution of the friction material, preventing unnecessary wastage of pads.

To this end, a brake pad for a disc brake caliper has been developed, comprising a support plate with a rear face presenting a support zone and a front face receiving a friction material with a friction zone intended to engage with a brake disc in a friction direction.

According to the invention, the center of the support zone is offset relative to the center of the friction zone, in a direction opposite to the friction direction, by a value D, such that 0.1 μE≤D≤2 μE, where:
μ is the coefficient of friction of the friction zone against the disc; and
E is the distance between the friction zone and the center of a mounting surface of the pad, measured orthogonally to the friction zone.

The Applicant has found that uneven wear of the pads is mainly due to an imbalance in the forces applied to the pads: the friction force, generated by the friction of the disc against the pad, tends to tilt the latter. Indeed, a moment is generated by transferring this friction force to the center of the sliding connection guiding the pad relative to the caliper that receives it.

Offsetting the center of the support zone according to the invention generates a counter-moment, which limits or even cancels the tilting tendency of the pad during use. This results in better wear distribution of the pad, which not only extends its lifespan but also improves braking performance by better controlling the distribution of clamping force and hence the heat generated.

Specifically, a uniform pressure distribution between the pad and the disc is achieved, leading to even wear across the entire pad surface and improved braking performance. Without this offset, wear differences lead to local pressure differences: some areas of the pad could experience a local pressure of only 20 bars, while others could experience 30 bars.

The average pressure is 25 bars, below a limit pressure, for example, 30 bars, beyond which the pad reaches its temperature limit, accelerating wear. However, areas experiencing 30 bars of pressure will heat up more than those at 20 bars, reaching this limit.

With the invention, the pressure is uniform across the support zone, allowing full utilization of the pad's capabilities without local areas degrading due to operating beyond acceptable limits.

The center of the support zone is the geometric center of the zone transmitting the clamping force to the pad. For example, in a pad driven by two pistons, it is the midpoint between the pistons' force application points on the pad. For the opposite pad, which is stationary, the center of the support zone is the geometric center of the surface normal to the clamping force direction, connecting the pad to the caliper. The center of the support zone is thus where the clamping force on the pad is considered to be applied.

The same reasoning applies to the center of the friction zone, which is the geometric center of the friction surface, where the disc's reaction force and friction force are considered to be applied.

The offset is measured in a direction opposite to the friction direction, considered tangential to the disc's rotation, at the center of the pad's friction zone.

Advantageously, D=μ*E. The pad thus mounted is perfectly balanced, and tilting is completely eliminated.

In a preferred embodiment, the mounting surface comprises two lugs, each configured to cooperate with a caliper bushing. This embodiment is simple to implement and inexpensive. In this case, the center of the mounting surface is located on the median plane of the support plate.

To ensure that the pad's offset is correctly oriented relative to the rotation direction, the pad includes fixing means on a caliper, which include means to prevent incorrect installation. Otherwise, the moment generated by the offset would add to the moment generated by the friction force, accelerating pad wear.

In a first embodiment of the preventing means, the support plate has a first lug of a first diameter and a second lug of a second diameter different from the first, with each lug configured to cooperate respectively with a first and a second caliper bushing, forming a sliding connection between the pad and the caliper. The preventing means are the diameter difference between the first and second lugs.

In this embodiment, the caliper has a first bushing of a first diameter and length, and a second bushing of a second diameter and different length, connecting the caliper's two jaws. The caliper receives pads with a support plate featuring a first lug of the first diameter and a second lug of the second diameter, each configured to cooperate respectively with the bushings.

In a second embodiment of the preventing means, the pad has an asymmetric part configured to allow passage of a caliper stop.

In this embodiment, the asymmetric part is a beveled corner of the support plate.

In this embodiment, the caliper includes two bushings connecting its two jaws; two pads with lugs configured to cooperate with the bushings; and a stop. The support plate has an asymmetric part configured to allow passage of the stop.

To present the necessary thermal characteristics for enhanced braking performance, the support plate is made of low-alloy steel, containing less than 0.3% by weight of carbon, preferably less than 0.2%, and vanadium in an amount between 0.2 and 0.3% by weight, with the remainder preferably being iron with foreseeable impurities. The plate is, for example, made of 15CDV6 steel. This material choice allows the pad to withstand significant temperature rises during intensive brake use. The presence of vanadium notably improves the plate's hot strength.

The invention also relates to a disc brake caliper receiving a pad according to the aforementioned characteristics.

The invention also relates to a disc brake receiving a caliper according to the aforementioned characteristics. Advantageously, the disc is made of carburizing steel containing less than 0.3% by weight of carbon, preferably 18NiCr5-4 or 16NC6. Choosing such a material for the disc allows compatibility with the pads according to the invention. Indeed, these pads enable better braking performance, necessitating significant heat dissipation briefly and repeatedly. Such temperature cycles act as quenching cycles for the disc, which may crack due to changes in its mechanical properties or thermal fatigue. Using carburizing steel helps mitigate these issues. Furthermore, knowing the disc material well allows accurate knowledge of the friction coefficient μ and thus the value of the offset to be applied.

### BRIEF DESCRIPTION OF THE DRAWINGS

FIG. 1 is a top view diagram illustrating the resolution of the fundamental principle of dynamics applied to a pad according to the invention during braking.

FIG. 2 is an exploded view illustration of a caliper according to the invention.

FIG. 3 is a partial front view of such a caliper.

FIG. 4 is a front view of a disc brake according to the invention.

FIG. 5 is a side view of such a brake.

FIG. 6 is a perspective view of a caliper of such a brake.

FIG. 7 is a partial front view of such a caliper.

### DETAILED DESCRIPTION OF THE INVENTION

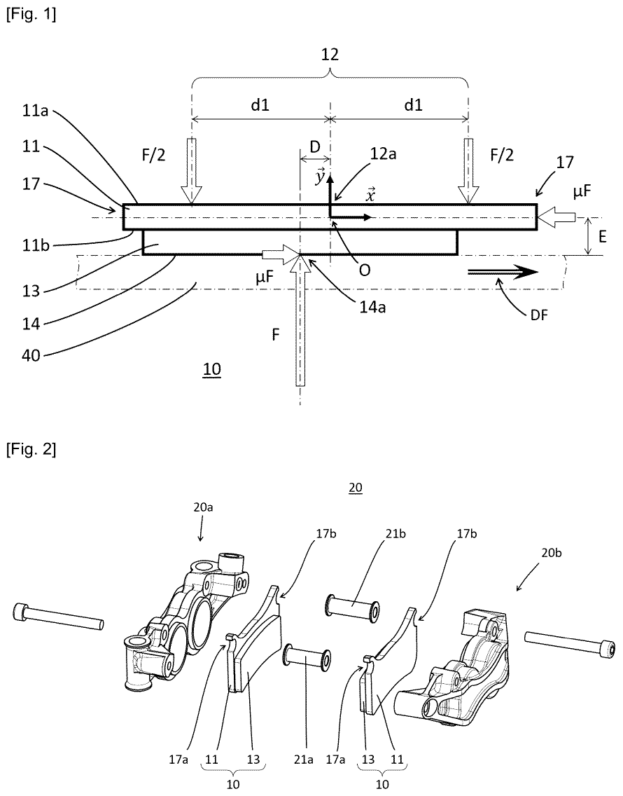

Referring to FIG. 1, the invention primarily lies in the offset of a friction material (13) of a brake pad (10) in a direction opposite to the braking direction (DF). This offset reduces or eliminates the tilting tendency caused by the friction force (μF) from a friction surface (14) to the center of the kinematic connection linking the pad (10) to the caliper (20) supporting it.

The pad (10) being flat, we define an orthonormal frame (O,x\vec{ },y\vec{ },z\vec{ }) where:
The plane (x\vec{ },z\vec{ }) is parallel to the friction surface (14);
The direction (z\vec{ }) is parallel to a disc radius (40) passing through the center O;
The center O of the frame is such that the center of the kinematic connection is on the x-axis, and the clamping force application point of the pistons on the pad (10) is on the y-axis.

The braking direction (DF) is thus parallel to the x-direction.

It is also possible to center the frame on the friction force application point: the offset being small, in the order of a few millimeters, the performance improvement is achieved regardless of the frame used among these two possibilities.

The generally observed wear imbalance of the friction material (13) is a lower height on the negative x side and a higher height on the positive x side, which remains fairly constant across the friction material height in the z-direction. It is therefore relevant to resolve the fundamental principle of dynamics (“FPD”) applied to the pad (10) in a two-dimensional projection in the (x\vec{ };y\vec{ }) plane, rather than in three dimensions.

In the illustrated embodiment, the kinematic connection is a sliding connection obtained by two lugs (17) on either side of a support plate (11) of the pad (10), cooperating with two bushings (21) not shown. Point O is at the median thickness of the plate (11), equidistant between the two lugs (17).

Resolving the FPD applied to the pad (10) at point O indicates that the distance E between the friction surface (14) where the friction force μF is applied generates a moment in the z-direction at point O. To counteract this tilting, an opposite moment can be generated by offsetting the application point of the disc force F on the pad (10) in the direction opposite to the friction direction (DF).

The offset value D can be adjusted as needed by a skilled person. For example, D strictly equals μ*E, where:
μ is the friction coefficient of the friction material (13) against the disc (40), and
E is the distance between the friction surface (14) and the center of the kinematic connection in the y-direction.

In this case, the moments of the forces cancel each other, and the pad (10) is balanced. E is a nominal value, measured on a new pad (10).

However, during use, the friction material (13) will wear and the distance E will decrease. Therefore, it may be advantageous to choose a D value that is lower, for example, between 0.3 μE and 0.7 μE, preferably 0.5 μE. Thus, the new pad (10) is unbalanced, but as the friction material (13) wears, the pad (10) tends to balance, for example, at mid-wear, before becoming unbalanced again as wear becomes significant. This mode keeps the pad (10) near equilibrium as long as possible.

Conversely, depending on the caliper's (20) dynamic behavior, it may be beneficial to choose a higher D value, for example, between 1.3 μE and 1.7 μE, preferably 1.5 μE. This may be necessary if the caliper has a particular dynamic, for example, if the clamping force is generated by two pistons of different sections.

In all cases, the D value is chosen such that 0.1 μE≤D≤2 μE.

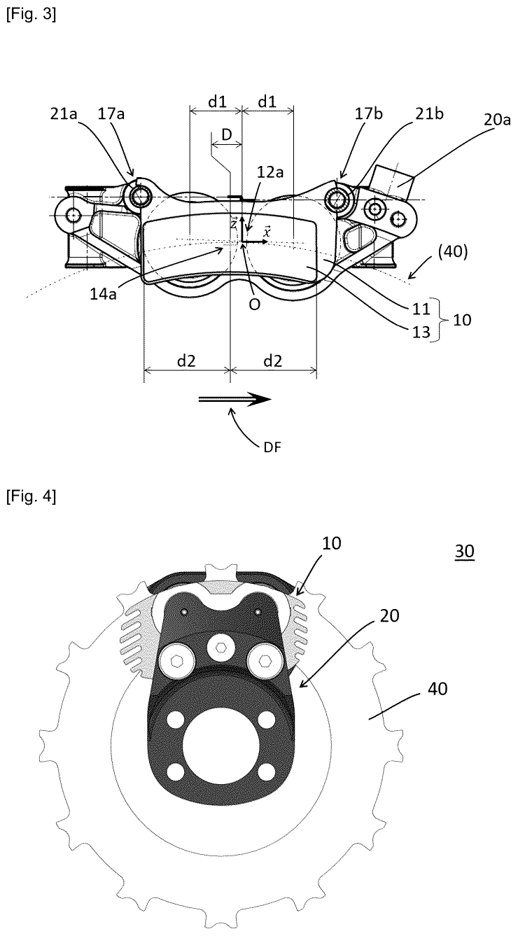

FIGS. 2 and 3 illustrate a first embodiment of a caliper (20) according to the invention. This caliper (20) includes a first jaw (20a) with two pistons connected to the master cylinder to apply the clamping force to the pads (10) gripping a disc (40) not shown. The second jaw (20b) does not have pistons. The caliper (20) includes two symmetric pads (10) according to the invention: one with the friction material offset to the left and the other to the right.

The first jaw (20a) and the second jaw (20b) are connected by a first bushing (21a) and a second bushing (21b) with different outer diameters. The assembly is fastened with screws. The bushings (21a, 21b) cooperate with a first lug (17a) and a second lug (17b) on the support plate (11), guiding the pads (10) in a sliding connection.

The diameters of the first lug (17a) and the second lug (17b) are respectively matched to the first bushing (21a) and the second bushing (21b), preventing incorrect installation of the pads (10). Incorrect installation would reverse the offset direction, amplifying the wear of the friction materials (13). The diameter difference of the bushings (21a, 21b) and corresponding lugs (17a, 17b) thus acts as a preventing means, ensuring the correct offset direction during pad (10) installation in the caliper (20).

To ensure the first bushing (21a) and the second bushing (21b) are not swapped in the caliper (20), their installation also includes preventing means. For example, the first bushing (21a) has a first length, and the second bushing (21b) has a different length.

The caliper (20) itself has its own preventing means to ensure correct installation on the vehicle.

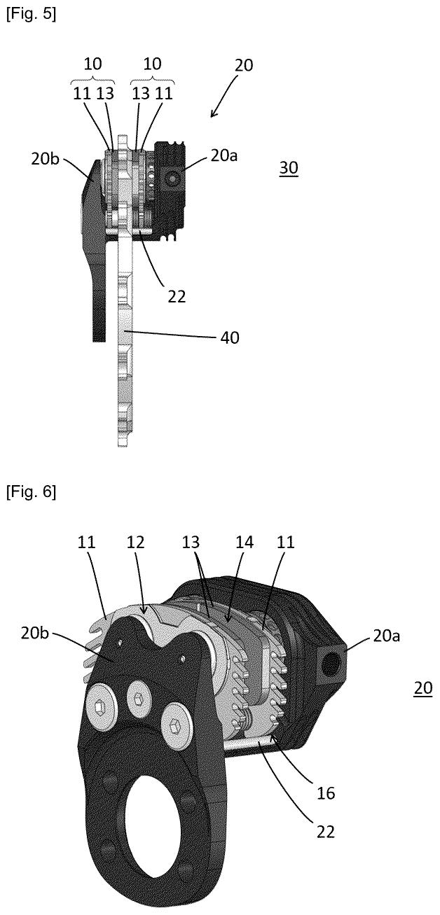

FIGS. 4 and 5 illustrate a brake (30) according to the invention, integrating a second embodiment of the caliper (20).

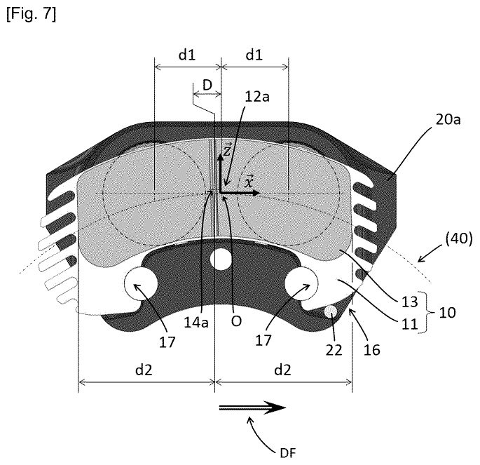

This caliper (20) is detailed in FIGS. 6 and 7, showing another embodiment of the preventing means preventing incorrect pad (10) installation. In this mode, the pads (10) are asymmetric, and the asymmetric part allows passage of a stop (22) fixed on the caliper (20).

In a preferred embodiment, the asymmetric part is a bevel (16) on the plate (11). If a user attempts to install the pad (10) incorrectly, the absence of a bevel (16) on the opposite part would be blocked by the stop (22), preventing installation.

The pad (10) according to the invention offers superior braking performance, leading to greater conversion of kinetic energy into thermal energy: the pads (10) and the disc (40) heat up more during use, reaching high temperatures exceeding 700° C. during intensive use, such as in motorsports or aircraft landing gear.

To enhance the plate's (11) temperature resistance, it is made of low-alloy steel containing less than 0.3% by weight of carbon, preferably less than 0.2%, and vanadium in an amount between 0.2 and 0.3% by weight, with the remainder preferably being iron with foreseeable impurities. The plate is, for example, made of 15CDV6 steel, suitable for this use.

Tests conducted by the Applicant compared 15CDV6 steel and a known steel “Imex700” or S 690 QL according to the European standard EN 10025-6: March 2005, initially used to make the plate (11).

The tests involved bending tests on Imex700 and 15CDV6 specimens with identical dimensions except for a 4 mm thickness for Imex 700 and a 3 mm thickness for 15CDV6. During the bending test, the specimen is held horizontally at one end by a clamp, and a weight is suspended at the other end. A section near the clamp is reduced to ensure bending occurs there. The distance between the free end and the reduced section is 150 mm.

The specimen is first tested at 21° C. by suspending weights until plastic deformation of the reduced section occurs.

Next, a new specimen is tested by suspending weights and heating the reduced section to 600° C. The specimen is then air-cooled, and its straightness is checked to determine if the elastic limit was exceeded. The tests are repeated with different weights until finding the elastic-plastic deformation limit.

The test results are compiled in the table below, noting that the induced stress was normalized to account for the thickness difference between the specimens.

TABLE 1

| | | | Induced | | | |
|---|---|---|---|---|---|---|
| | Thickness | Bending | Stress | | | |
| Steel | (mm) | Weight (kg) | (Mpa) | Twisted | Heated | |
| 15CDV6 | 3 | 14.06 | 1970 | Yes | 21° | C. |
| 15CDV6 | 3 | 7.02 | 984 | Yes | 600° | C. |
| 15CDV6 | 3 | 5.6 | 785 | No | 600° | C. |
| Imex700 | 4 | 17 | 1340 | Yes | 21° | C. |
| Imex700 | 4 | 8.62 | 680 | Yes | 600° | C. |
| Imex700 | 4 | 5.82 | 459 | No | 600° | C. |

The results show that 15CDV6 withstands an induced stress of 785 Mpa when heated to 600° C., while Imex 700 withstands only 459 Mpa, making 15CDV6 70% more resistant than Imex700.

The high rotational speed of the disc (40) induces rapid cooling by convection, causing the disc (40) to undergo quenching cycles at regular intervals. These temperature cycles result in thermal fatigue of the disc (40), making it brittle.

To address this, the disc (40) is made of non-quenching carburizing steel, i.e., containing less than 0.3% carbon. Such a disc (40) is less sensitive to the temperature cycles experienced with the improved pad (10) according to the invention.

Moreover, the pad (10), caliper (20), and brake (30) can be configured differently from the given examples without departing from the invention's scope, defined by the claims.

Specifically, the offset value can be adjusted based on a brake's (30) particular dynamic configuration and the desired balance point (e.g., when the pad is new).

Furthermore, the technical features of the different embodiments and variants mentioned above can be combined with each other, in whole or in part. Thus, the pad (10), caliper (20), and brake (30) can be adapted in terms of cost, functionality, and performance.

1. Brake pad for a disc brake caliper, comprising a support plate with a rear face presenting a support zone and a front face receiving a friction material with a friction zone intended to engage with a brake disc in a friction direction, characterized in that the center of the support zone is offset relative to the center of the friction zone, in a direction opposite to the friction direction, by a value D, such that 0.1 μE≤D≤2 μE, where:
μ is the friction coefficient of the friction zone against the disc; and
E is the distance between the friction zone and the center of a mounting surface of the pad, measured orthogonally to the friction zone.

2. Brake pad according to claim 1, characterized in that D=μ*E.

3. Brake pad according to claim 1, characterized in that the mounting surface comprises two lugs, each configured to cooperate with a caliper bushing.

4. Brake pad according to claim 1, characterized in that it includes fixing means on a caliper, said fixing means comprising preventing means for the correct installation direction of the pad in the caliper.

5. Brake pad according to claim 4, characterized in that the support plate has a first lug of a first diameter and a second lug of a second diameter different from the first, with each lug configured to cooperate respectively with a first bushing and a second bushing of a caliper, forming a sliding connection between the pad and the caliper, and the preventing means is the diameter difference between the first and second lugs.

6. Brake pad according to claim 4, characterized in that the pad has an asymmetric part configured to allow passage of a caliper stop.

7. Brake pad according to claim 6, characterized in that the asymmetric part is a beveled corner of the support plate.

8. Brake pad according to claim 1, characterized in that the support plate is made of low-alloy carbon steel, containing less than 0.3% by weight of carbon, preferably less than 0.2%, and vanadium in an amount between 0.2 and 0.3% by weight.

9. Caliper for a disc brake receiving a brake pad said brake pad comprising a support plate with a rear face presenting a support zone and a front face receiving a friction material with a friction zone intended to engage with a brake disc in a friction direction, characterized in that the center of the support zone is offset relative to the center of the friction zone, in a direction opposite to the friction direction, by a value D, such that 0.1 μE≤D≤2 μE, where:
μ is the friction coefficient of the friction zone against the disc; and
E is the distance between the friction zone and the center of a mounting surface of the pad, measured orthogonally to the friction zone.

10. Caliper according to claim 9, characterized in that it includes a first bushing of a first diameter and length, and a second bushing of a second diameter and length different from the first, connecting two jaws of the caliper, and receiving pads with a support plate featuring a first lug of the first diameter and a second lug of the second diameter, each lug configured to cooperate respectively with the bushings.

11. Caliper according to claim 9, characterized in that it includes:
two bushings connecting two jaws of the caliper;
two pads with lugs configured to cooperate with the bushings; and
a stop;
the support plate has an asymmetric part configured to allow passage of the stop.

12. Disc brake configured to receive a caliper said caliper receiving a brake pad comprising a support plate with a rear face presenting a support zone and a front face receiving a friction material with a friction zone intended to engage with a brake disc in a friction direction, characterized in that the center of the support zone is offset relative to the center of the friction zone, in a direction opposite to the friction direction, by a value D, such that 0.1 μE≤D≤2 μE, where:
μ is the friction coefficient of the friction zone against the disc; and
E is the distance between the friction zone and the center of a mounting surface of the pad, measured orthogonally to the friction zone; and
said disc brake further comprising a disc made of carburizing steel.

13. Disc brake of claim 12 wherein the carburizing steel is one of 18NiCr5-4 or 16NC6.
